(19) United States
(12) Patent Application Publication
(10) Pub. No.: US 2015/0314730 A1
(43) Pub. Date: Nov. 5, 2015

(54) SYSTEM AND METHOD FOR ADJUSTING IMAGE USING IMAGING DEVICE

(71) Applicant: Hyundai Motor Company, Seoul (KR)

(72) Inventors: Jun Sik An, Hwaseong (KR); Joong Ryoul Lee, Incheon (KR); Kap Je Sung, Bucheon (KR); Eu Gene Chang, Gunpo (KR)

(21) Appl. No.: 14/569,721

(22) Filed: Dec. 14, 2014

(30) Foreign Application Priority Data
May 2, 2014 (KR) 10-2014-0053396

(51) Int. Cl. B60R 1/00; H04N 5/232; G06T 3/00

(52) U.S. Cl. CPC B60R 1/00; G06T 3/00; H04N 5/23229

(57) ABSTRACT

An imaging device model system and a method are provided for adjusting an image which may allow a driver to receive an image having a minimized blind spot using a converted image and to view a wider range of the image without distortion using an imaging device. The system includes an imaging device that is configured to capture real images of sides and a rear of a vehicle. The system also includes an input unit configured to move, expand, or reduce the real images and a imaging device model unit that is configured to project the real images onto a projection surface to generate virtual viewpoint images and then convert parameters of the virtual viewpoint images to generate converted images. In addition, an output unit is configured to output the converted images.

### CROSS-REFERENCE TO RELATED APPLICATION(S)

Pursuant to 35 U.S.C. §119(a), this application claims the benefit of Korean Patent Application No. 10-2014-0053396, filed on May 2, 2014, the disclosure of which is incorporated herein in its entirety by reference.

### BACKGROUND

1. Field of the Invention

The present disclosure relates to a system and method for adjusting an image using an imaging device, and more particularly, to a technology of replacing side mirrors using image conversion for images captured by the imaging device.

2. Discussion of the Related Art

Generally, a vehicle includes side mirrors to enable a driver to view left and right road conditions or to view rear road conditions while driving. The side mirrors may be disposed at both sides of a vehicle body to assist with various functions which may be essential for safe driving. The side mirrors may assist a driver in safely changing lanes, maintaining a safe distance from other vehicles, and operating safely without hindering drivers of other vehicles, (e.g., vehicles approaching from the rear), by allowing a driver to recognize a driving direction, a speed, or the like, of other vehicles approaching from the rear via the use of convex mirrors attached to bodies of the side mirrors, while maintaining a gaze to the front, left or right.

Side mirrors are generally disposed on the left and right vehicle body surfaces above the head lamps or on front, exterior portions of the driver and passenger doors, to allow a driver to view rear or side traffic conditions. Meanwhile, since the side mirror disposed at the passenger side is displaced at a distance from a driver's seat, an angle of reflection of the mirror which may be seen by a driver is minimal relative to the angle of reflection of the driver side mirror. Therefore, to substantially enlarge a driver's viewing angle, a mirror which protrudes from both sides of a side view mirror toward a center thereof (e.g., a convex mirror) may be disposed on the side mirror but has a critical defect in that a blind spot may remain in the driver's field of view.

Further, when the side mirrors on the driver's side or the passenger side of the vehicle are plane mirrors, the side mirrors suffer less from negative refractive phenomena, and therefore may not provide an accurate sense of distance and an accurate reflection of shape. However, such plane side mirrors have a substantially small viewing angle, such that a blind spot may be generated to the side of the vehicle. As a result, the plane side mirrors, according to the related art, which are disposed on a vehicle have a substantially small rear viewing angle. The center convex type side mirror which is devised to alleviate the above problem suffers from a disadvantage in that such mirrors do not allow a driver to ascertain accurate distances and relative positions of vehicles traveling to the side and rear of the driver. This problem results from a convex viewing angle due to a refractive phenomenon inherent in the convex glass material. This negative phenomenon may increase a risk of collision with vehicles traveling on the sides and the rear when a driver attempts a left or a right turn, and the like. Further, to solve the above problem, when a vehicle has exterior side mirrors which are provided with auxiliary convex mirrors, such mirrors may need to be adjusted depending on the body conditions of different drivers of the same vehicle, and therefore may require complicated adjustment devices.

### SUMMARY

The present invention provides a system and method for converting an image into an image simulating various types of mirrors using a imaging device model and further provides a system and a method for adjusting an image which may allow a driver to receive an image having a reduced or minimized blind spot using a converted image and view a wider range of the image without distortion using an imaging device.

According to an exemplary embodiment of the present invention, a system for adjusting an image using an imaging device may include: a controller configured to communicate with the other components; an imaging device configured to capture real images of sides and a rear of a vehicle; an input unit configured to move, expand, or reduce the real images; a imaging device model unit configured to project the real images onto a projection surface to generate virtual viewpoint images and then convert parameters of the virtual viewpoint images to generate converted images; and an output unit configured to output the converted images. The parameter may include a lens, a sensor, a focal distance of the imaging device, a position or a rotation angle of the imaging device. A curved surface minor or a wide mirror may be modeled by changing the projection surface to generate the converted image. The converted image may be converted into an image simulating a mirror by combining different projection models. The input unit may include any one of a mirror adjustment switch, a touch pad, and a slide switch.

According to another exemplary embodiment of the present invention, a method for adjusting an image using an imaging device may include: operating, by a controller, an imaging device to capture real images of sides and a rear of a vehicle; operating, by the controller, a projector to project the real images onto a projection surface to generate virtual viewpoint images and then converting parameters of the virtual viewpoint images to generate converted images; and outputting, by the controller, the converted images. The parameter may include a lens, a sensor, a focal distance of the imaging device, a position or a rotation angle of the imaging device. A curved surface mirror or a wide mirror may be modeled by changing the projection surface to generate the converted image. The converted image may be converted, by the controller, into an image simulating a mirror by combining different projection models. The real image may be adjusted, by the controller, by allowing a driver to use any one of a mirror adjustment switch, a touch pad, and a slide switch.

### BRIEF DESCRIPTION OF THE DRAWINGS

The drawings are provided for reference in describing exemplary embodiments of the present invention, and the spirit of the present invention should not be construed only by the accompanying drawings. The above and other objects, features and other advantages of the present invention will be more clearly understood from the following detailed description when taken in conjunction with the accompanying drawings, in which:

FIG. 1 is an exemplary configuration diagram for describing a system for adjusting an image using an imaging device according to an exemplary embodiment of the present invention;

FIGS. 2A to 2C are exemplary views for explaining a method for adjusting an image using an imaging device according to an exemplary embodiment of the present invention; and

FIG. 3 is an exemplary diagram for explaining the method for adjusting an image using an imaging device according to an exemplary embodiment of the present invention; and

FIGS. 4A and 4B are exemplary diagrams for explaining converted real image using the method for adjusting an image according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

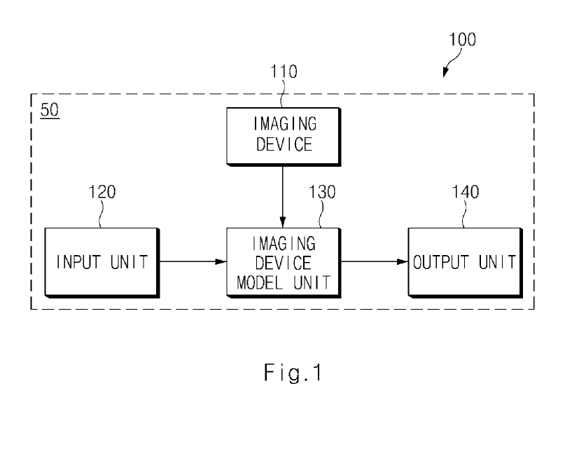

FIG. 1 is an exemplary configuration diagram for describing a system for adjusting an image using an imaging device according to an exemplary embodiment of the present invention. Referring to FIG. 1, a system 100 for adjusting an image may include a controller 50 configured to communicate with other components; an imaging device 110, an input unit 120, a imaging device model unit 130, and an output unit 140. The imaging device 110 may be a real camera, a video camera or the like, and may be disposed at one or both sides or a rear of a vehicle to capture a real image when the vehicle is being driven or is stationary. The image captured by the imaging device 110 may be a real image, and therefore a position of an imaging device 110 may be freely changed.

The input unit 120 may include an input device which may be used when a driver intends to look at the sides and/or rear of the vehicle. Various types of input devices such as a mirror adjusting switch, a touch pad, and a slide switch may be used as the input unit 120. In particular, the input unit 120 may be disposed at a position near a driver and may be manipulated at the time of driving or non-driving. The driver may choose to adjust a region of interest (ROI) of the real image or adjust reduction and expansion, and the like of the real image through the input unit 120. The imaging device model unit 130 may model optical characteristics of the imaging device to extract parameters and may design various projection models according to a usage of the image.

In other words, the imaging device model unit 130 may be configured to use the real image captured by the imaging device 110 to generate a virtual viewpoint image for a virtual camera having a predetermined virtual viewpoint defined according to vehicle driving conditions or a driver's selection. In particular, the imaging device model unit 130 may be configured to project the real image captured by the imaging device 110 onto a projection surface to generate the virtual viewpoint image. In the virtual viewpoint image, the image may be expanded and reduced or the region of interest of the image may be changed, based on the parameters extracted by modeling the optical characteristics of the imaging device. For example, the methods for generating a virtual viewpoint image by projecting the real image onto the projection surface may vary while remaining within the inventive concepts. Among the methods, there may be included a method for mapping a real image to a 3D model to obtain a texture map.

The parameters discussed above may be divided into internal and external parameters. The internal parameter may include a focal distance f, and the like, of a lens, a sensor, or an imaging device (e.g., a camera or a video camera, or the like) and the external parameter may include positions Tx, Ty, and Tz of the imaging device, rotation angles Rx, Ry, and Rz of the imaging device, and the like. The method for extracting parameters may include extracting mathematical-model-based imaging device characteristic parameters and may use a spherical model, the position of the imaging device, and the optical characteristics of the sensor or the lens disposed within the imaging device. Further, the imaging device model unit 130 may be configured to convert the image by simulating the virtual viewpoint images to various types of mirrors using various projection models according to the usage of the image. The projection model may include a compensation model for improving a sense of difference of the image.

Generally, the imaging device model unit 130 may be configured to design an image changed to a linear form by applying one virtual imaging device model and the parameters when the real image is projected onto the projection surface, but in the exemplary embodiment of the present invention, may be configured to convert the real image into an image simulating the mirror by changing the parameters for each region of the image or combining different projection models. The projection model may be configured to model the side mirrors with which various types of mirror shapes such as a curved surface mirror and a wide mirror in addition to a typical plane mirror are coupled. For example, the imaging device model unit 130 may be configured to design a projected model by applying a convex mirror effect to a lower end of a rear image of the vehicle or a convex mirror effect to an exterior of a side image of the vehicle. The output unit 140 may be configured to output the converted image from the imaging device model unit 130 to various display devices. The output unit 140 may include navigation, mobile display, head up display (HUD), or the like.

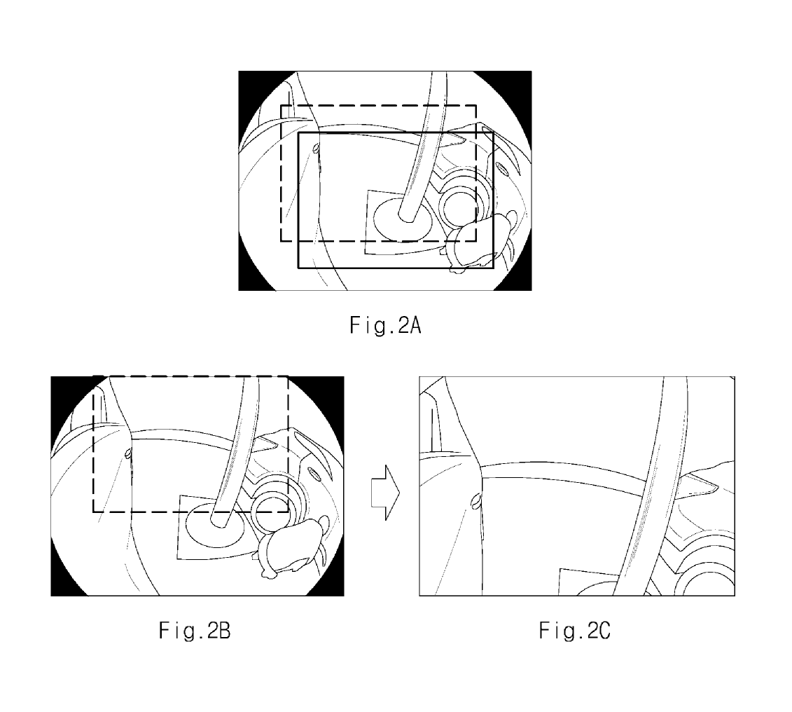

FIGS. 2A-2C are exemplary images for explaining a method for adjusting an image using an imaging device according to an exemplary embodiment of the present invention. Referring to FIGS. 2A-2C, after the real image captured by the imaging device model unit 130 is projected onto the projection face to generate the virtual viewpoint image, the method for adjusting an image may change the expansion, reduction, or region of interest of the image based on the parameters extracted by modeling the optical characteristics of the imaging device at the virtual viewpoint image. In particular, FIG. 2A is an exemplary diagram illustrating a change in the region of interest (ROI) of the image, FIG. 2B is an exemplary diagram illustrating a reduction in the image, and FIG. 2C is an exemplary diagram illustrating an expansion of the image.

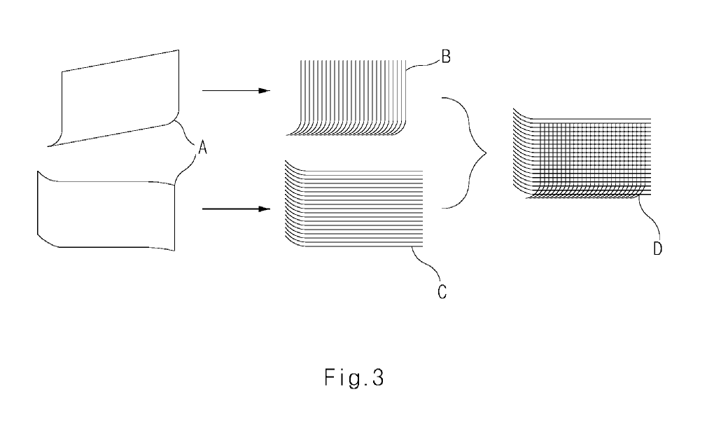

FIG. 3 is an exemplary diagram for explaining the method for adjusting an image according to an exemplary embodiment of the present invention. Referring to FIG. 3, the method for adjusting an image may simulate virtual viewpoint images to various types of mirrors using various projection models according to the usage of the image, thereby converting the image. In the case of designing various projection models according to the usage of the image, the method for adjusting an image may change or mix a column line B, a row line C, or parameters in a pixel unit of the virtual viewpoint image A to convert the virtual viewpoint image into an image D simulating various types of mirrors. The image may be designed to model various curved surface mirrors, wide or aspheric mirrors, in addition to a plane mirror used in a side mirror of an existing vehicle. For example, alternative images considering various driving conditions may be provided by adjusting the output images, at which the driver looks, to various types (e.g., the change in expansion, reduction, region of interest, and the like).

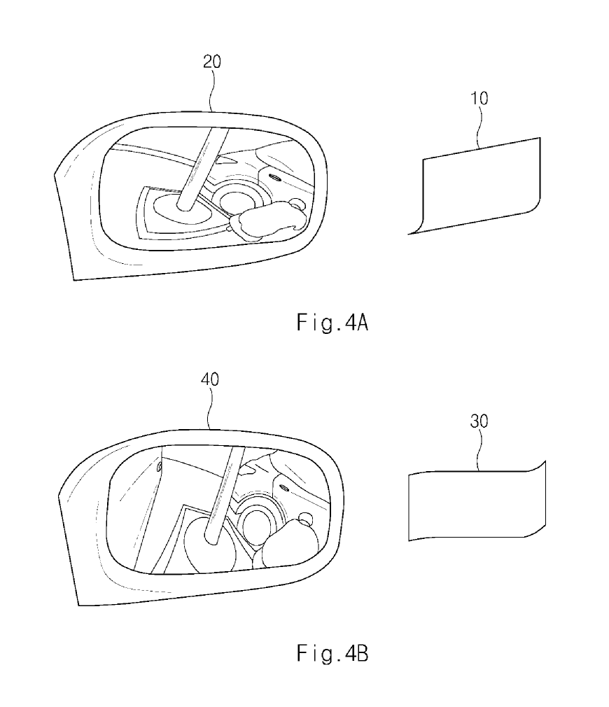

FIGS. 4A and 4B are exemplary diagrams for explaining converted real images using a method for adjusting an image according to an exemplary embodiment of the present invention. Referring to FIG. 4, such methods may be applied to converted real image modeling convex projection surface (10, 30) of a bottom of an image or a side of an image on a mirror or a side mirror (20, 40). As described above, according to exemplary embodiments of the present invention, it may be possible to increase the driver's convenience to meet various driving conditions by converting the image into another image simulating various types of mirrors using the imaging device model and it may be possible to reduce or minimize a blind spot and to allow a driver to view the wider range of view in an image, without distortion, by replacing the side mirrors according to the related art.

Further, according to exemplary embodiment of the present invention, improvement of the design of a vehicle may be possible. In addition, exemplary embodiments of the present invention may be used in various services by linking a vehicle with blind spot detection (BSD) and rear cross traffic alert (RTCA), by replacing the side mirrors according to the related art.

Although exemplary embodiments of the present invention have been disclosed based on restricted configuration and drawings, the technical ideas of the present invention are not limited thereto. Therefore, those skilled in the art will appreciate that various modifications and changes may be made, without departing from the scope and spirit of the disclosure as disclosed in the accompanying claims.

What is claimed is:

1. A system for adjusting an image using an imaging device comprising:
a memory configured to store program instructions; and
a processor configured to execute the program instructions, the program instructions when executed configured to:
operate the imaging device configured to capture real images of sides and a rear of a vehicle;
operate, an input unit configured to move, expand, or reduce the real images;
operate a imaging device model unit configured to project the real images onto a projection surface to generate virtual viewpoint images and then convert parameters of the virtual viewpoint images to generate converted images; and
operate, by the processor, an output unit configured to output the converted images.

2. The system according to claim 1, wherein the parameter includes at least one selected from the group consisting of: a lens, a sensor, a focal distance of the imaging device, a position, and a rotation angle of the imaging device.

3. The system according to claim 1, wherein a curved surface mirror or a wide mirror is modeled by changing the projection surface to generate the converted image.

4. The system according to claim 1, wherein the converted image is converted into an image simulating a minor by combining different projection models.

5. The system according to claim 1, wherein the input unit includes at least one selected from the group consisting of: a mirror adjustment switch, a touch pad, and a slide switch.

6. A method for adjusting an image using an imaging device, the method comprising:
operating, by a controller, an imaging device to capture real images of sides and a rear of a vehicle;
operating, by the controller, a projector to project the real images onto a projection surface to generate virtual viewpoint images and then converting parameters of the virtual viewpoint images to generate converted images; and
outputting, by the controller, the converted images.

7. The method according to claim 6, wherein the parameter includes at least one selected from the group consisting of: a lens, a sensor, a focal distance of the imaging device, a position and a rotation angle of the imaging device.

8. The method according to claim 6, wherein a curved surface mirror, a wide or an aspheric minor is modeled by changing the projection surface to generate the converted image.

9. The method according to claim 6, wherein the converted image is converted into an image simulating a minor by combining different projection models.

10. The method according to claim 6, wherein the real image is adjusted by at least one selected from the group consisting of: a minor adjustment switch, a touch pad, and a slide switch.

11. A non-transitory computer readable medium containing program instructions executed by a controller for adjusting an image using an imaging device, the computer readable medium comprising:
program instructions that operate an imaging device to capture real images of sides and a rear of a vehicle;
program instructions that operate a projector to project the real images onto a projection surface to generate virtual viewpoint images and then converting parameters of the virtual viewpoint images to generate converted images; and
program instructions that output the converted images.

12. The non-transitory computer readable medium according to claim 11, wherein the parameter includes at least one selected from the group consisting of: a lens, a sensor, a focal distance of the imaging device, a position and a rotation angle of the imaging device.

13. The non-transitory computer readable medium according to claim 11, further comprising:
program instructions that model a curved surface minor, a wide or an aspheric minor by changing the projection surface to generate the converted image.

14. The non-transitory computer readable medium according to claim 11, further comprising:
program instructions that convert the converted image into an image simulating a minor by combining different projection models.

15. The non-transitory computer readable medium according to claim 11, further comprising:
program instructions that adjust the real image by at least one selected from the group consisting of: a mirror adjustment switch, a touch pad, and a slide switch.
